(19) United States
(12) Patent Application Publication
(10) Pub. No.: US 2014/0067265 A1
(43) Pub. Date: Mar. 6, 2014

(54) ROAD CONDITION TRACKING AND PRESENTATION

(71) Applicant: Robert A. Maston, Columbus, OH (US)

(72) Inventor: Robert A. Maston, Columbus, OH (US)

(73) Assignee: CVG MANAGEMENT CORPORATION, New Albany, OH (US)

(21) Appl. No.: 13/596,761

(22) Filed: Aug. 28, 2012

(51) Int. Cl. G01C 21/36; G01C 21/34

(52) U.S. Cl. CPC G01C 21/3697; G01C 21/3453
USPC 701/533; 340/425.5; 340/905

(57) ABSTRACT

Systems and methods can discover and present to a user road conditions. A client can include sensors to measure local road conditions. Local road conditions can be measured by a sensor and reported to a server. The server can aggregate road condition information at least by location and time, and return the aggregated information to clients to facilitate presentation of road conditions not discovered locally. Information regarding road conditions at given times and locations can facilitate road maintenance coordination and route planning.

### TECHNICAL FIELD

This subject invention relates to monitoring road conditions and, more particularly, to systems and methods of measuring and mapping the temperature of road surfaces.

### BACKGROUND

The world's improved roads and highway systems provide incredibly flexible transportation opportunities for people and cargo. According to some statistics, the trucking industry delivers a majority of all freight in the United States, and the U.S. transportation industry can log annual mileage totals in the in the hundreds of billions. At local levels, cities and municipalities often maintain fleets of vehicles that are instrumental to providing services throughout the community. One such service is maintenance of the roads themselves.

The efficiency and safety on many improved surfaces can vary significantly based on road conditions. During cold weather, snow and ice can affect traction in dangerous ways. Further, roads with even modest amounts of standing snow can be inefficient to drive based on the increased resistance to forward motion, compounding the effects of cold weather on tire pressure. While many roads today are plowed or treated in cold weather, it is difficult for drivers to know when or where such treatments have recently been completed. It can also be challenging to coordinate road maintenance between crews and across borders.

In addition, roads are developed with materials that can become very hot due to sunlight, air temperature, and other factors. The heat of the road combined with the friction from tire movement can cost vehicle operators in terms of efficiency and safety. Heat can materially impact the pressure of gas in a tire, which directly impacts how many miles a vehicle can travel per unit of fuel. Further, heat affects the mechanical properties of tires, causing faster and uneven wear, reducing the mileage life of the tread. At extreme temperatures, the physical properties of tires can become unpredictable, resulting in mechanical failure during operation that would be safe in most temperatures.

A variety of other road conditions can impact the efficiency and safety of travel. Flooding, fallen trees, landslides, and other natural phenomenon have the ability to snarl roadways in some areas. Even the serviceability of a road surface, such as whether it is crumbling or seriously degraded with holes, can reduce a vehicle's gas mileage and place the driver in danger.

Accordingly, it would benefit drivers to be aware of current road conditions, both at their current location and along their travel route.

### SUMMARY

The following presents a simplified overview of the innovation in order to provide a basic understanding of some aspects of the innovation. This overview is not an extensive summary of the innovation. It is not intended to identify key/critical elements of the innovation or to delineate the scope of the innovation. Its sole purpose is to present some concepts of the innovation in a simplified form as a prelude to the more detailed description that is presented below.

The innovation disclosed and claimed herein generally relates to discovering, measuring, transmitting, receiving, estimating, and presenting road conditions, and the utilization of road condition information. While some aspects are generally directed toward road temperature, it is appreciated that a variety of road and environmental conditions influencing efficiency and safety can be utilized in accordance with the disclosures herein without departing from the scope or spirit of the subject innovation.

In some aspects herein, a sensor can measure a local road condition for local display. For instance, conditions such as temperature, presence of ice, presence of snow, presence of other debris, etc. can be measured in accordance with the innovation. In additional aspects herein, a sensor can measure a local road condition that is transmitted, with location and time, to another device, server or storage location.

In further aspects herein, remote road conditions can be received, associated with location and time, for display on a local device. In still further aspects herein, road conditions can be estimated where comprehensive or current information is unavailable.

In accordance with the innovation, road maintenance can be coordinated, automatically or manually, utilizing systems and methods disclosed herein. For example, route planning and re-planning can be accomplished utilizing systems and methods disclosed herein. The innovation can be applied to road maintenance crews (e.g., Departments of Transportation or DOTs), long-haul transportation, delivery services, public transportation, personal transportation, etc.

To the accomplishment of the foregoing and related ends, certain illustrative aspects of the innovation are described herein in connection with the description. These aspects are indicative, however, of but a few of the various ways in which the principles of the innovation can be employed and the subject innovation is intended to include all such aspects and their equivalents. Other advantages and novel features of the innovation can become apparent from the following detailed description of the innovation.

### BRIEF DESCRIPTION OF THE DRAWINGS

FIG. 1 illustrates a block schematic diagram of an example road condition mapping system in accordance with aspects;

FIG. 2 illustrates an example road condition mapping system on a vehicle in accordance with aspects of the innovation;

FIG. 3 illustrates an example user display in accordance with aspects of the innovation;

FIG. 4 illustrates a flowchart of an example method for presenting road conditions;

FIG. 5 illustrates a flowchart of an example method for transmitting and receiving road condition data;

FIG. 6 illustrates a flowchart of an example method for determining, including estimating, road conditions;

FIG. 7 illustrates an example computing environment that can be included in or used with some components in accordance with an aspect of the innovation; and

FIG. 8 illustrates an example communications environment that can be included in or used with some components in accordance with an aspect of the innovation.

### DETAILED DESCRIPTION

Systems and methods relating to discovering, measuring, transmitting, receiving, estimating and displaying road conditions, and the utilization of such information are disclosed. A sensor can measure local road conditions, which can be displayed to a local user, and/or sent to a remote user or server for storage.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable or script, a thread of execution, a program, a computer, and/or information relevant to effecting the desired function. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not to be construed as preferred or advantageous over other aspects or designs.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

Various aspects will be presented in terms of systems that may include a number of components, modules, and the like. It is to be understood and appreciated that the various systems may include additional components, modules, et cetera and/or may not include all of the components, modules, et cetera discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

As used herein, a “road” can be any vehicle trafficable surface. A “route” can be a single road, or a series of roads that can be reached by one another.

As used herein, a “road condition” or similar language can be used to represent the state of a trafficable surface. For example, the presence of ice, snow, water, obstructions, and other on-surface material can be a road condition. The temperature of the road can also be a road condition. While most road conditions described herein pose a hazard, not all road conditions need be dangerous. In some embodiments, the lack of any unusual road condition is a road condition in and of itself (e.g., road is trafficable and there is nothing wrong with the road at this time). A change to a road condition can include a natural or human-effected improvement to a hazardous route condition, or an increase in the hazard on a previously safe road.

As used herein “maintenance” or “treatment” with respect to a road or route can be action taken (e.g., by municipal employees) to reconcile a hazardous road condition. In a non-limiting example, maintaining or treating a route can include distributing salt (salting) or other treatment to an icy road.

The term “display” as used herein is not intended to limit the scope of particular presentations to visual techniques. While “display” can be used for brevity or ease of use, other techniques, such as audible information and touch-based information (e.g., vibration notifications) can be employed independently or in conjunction with a visual display without departing from the spirit of the innovation.

The innovation is now described with reference to the drawings, wherein like reference numerals are used to refer to like elements throughout. In the following description, for purposes of explanation, numerous specific details are set forth in order to provide a thorough understanding of the subject innovation. It can be evident, however, that the innovation can be practiced without these specific details. In other instances, well-known structures and devices are shown in block diagram form in order to facilitate describing the innovation.

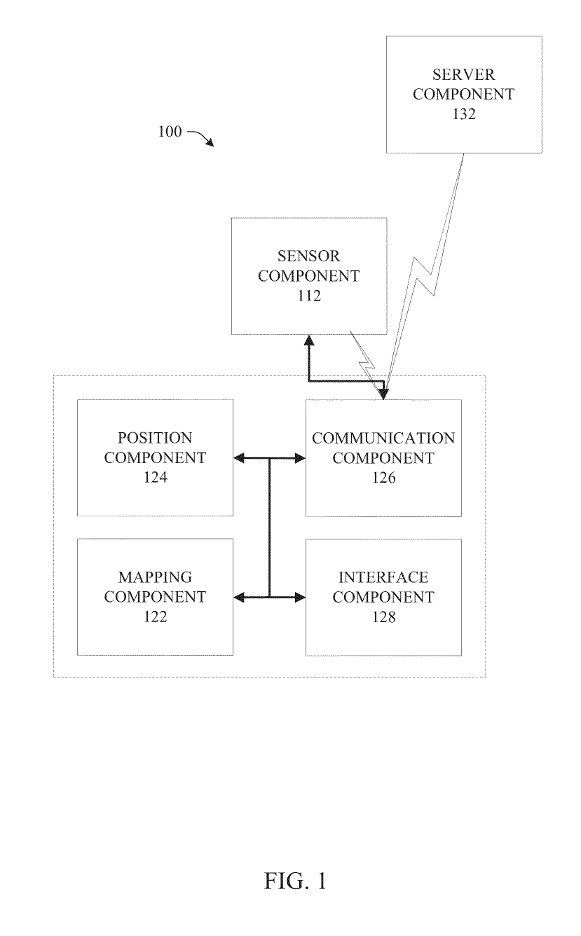

Referring initially to the drawings, FIG. 1 illustrates an example schematic block component diagram of a system 100 in accordance with aspects of the innovation. As illustrated, system 100 can include sensor component 112, which interacts with a plurality of other components. Other components can include mapping component 122, position component 124, interface component 128 and communication component 126. While mapping component 122, position component 124, interface component 128 and communication component 126 are shown as collocated or contained together in system 100, it is appreciated that one or more of these components can be located remotely, operate as a stand-alone aspect, and/or be housed in one or more other components where all are not simultaneously contained in a single physical entity. System 100 can also include server component 132, which can be local or remote (or some combination thereof) from other components of system 100.

Sensor component 112 can be used, for example, to measure or determine road conditions. Sensor component 112 can include an infrared (IR) sensor for determining a road surface temperature. An infrared temperature sensor can be mounted to a vehicle and continuously measure the surface temperature on or near the vehicle's path of travel. This temperature can be used to determine the presence or risk of ice, extreme heat, and other hazardous road conditions. In addition to continuous monitoring and measurement, it is to be appreciated that measurement and/or transmission of data can be performed iteratively, e.g., based upon a desired schedule or program as desired or appropriate.

In some embodiments, sensor component 112 can also include other sensors used to detect or infer road conditions. For example, a camera or other photo sensor can be used to discern a variety of road conditions. A camera can be directed toward the road, or at the road ahead, and capture and/or recognize a variety of useful details about the road surface. Snow and ice can be detected in this way, based on visual characteristics such as color contrast, reflection, visual changes from known road conditions, and varying heights or patterns appearing in the nearest surface to the vehicle (e.g., snow drifts, tire tracks easily visible). Active precipitation, including snowfall, can also be detected and processed by system 100 when captured through image processing (e.g., snowflakes or raindrops visible). In some embodiments, heat can be detected by recognizing the presence of a mirage. Even pavement or asphalt wear can be determined if regular visual inconsistencies can be seen, indicating holes or wear. By attributing additional characteristics of roads that can be captured by camera or other sensor means, databases can also provide improved estimates of road conditions where road conditions are otherwise uncertain, as will be discussed later.

Mechanically based motion sensors can also be employed to discern road conditions. For example, if a mechanical sensor is jolted regularly during regular normal operation, the road surface can be determined uneven or degraded by potholes. If a mechanical sensor detects sudden swerving, a determination about the presence of obstructions or an otherwise difficult area of road can be stored. Continuous swerving can indicate a winding road that requires additional caution.

In some embodiments, sensor component 112 can detect other types of energy to provide additional route-based information not directly related to roads. In one embodiment, sensor component 112 can detect radar or laser energy to alert a user of a possible “speed zone,” or position where a vehicle's speed is being measured or recorded. In such embodiments, the location and time of the suspected speed zone can be recorded for local display, and/or passed to other devices or servers to facilitate display of the speed zone's location (or at least the area of road affected by the speed zone located nearby) to other users. Information regarding a suspected speed zone can be detected, transmitted, received and mapped in the same fashion as other road condition information herein. In another embodiment of sensor component 112, radio energy can be detected to indicate the presence of communication over radios or other wireless means in range, including what frequencies and protocols transmissions are being sent over.

Sensor component 112 can detect a variety of otherwise difficult-to-predict or unpredictable road conditions. Such road conditions can include acute or chronic hazard areas that do not reflect larger trends for the roadway or region. For example, areas that freeze atypically fast, such as bridges, areas that receive limited sunlight (e.g., shaded areas of roadway), and areas with high amounts of condensation can be detected, recorded, and understood with greater certainty. Hazards caused or influenced by local micro-climates can be discovered, and trends or general impact can be disseminated or analyzed. Other road conditions, such as potholes, can be discovered and recorded, utilizing sensor component 112 or other modules described infra.

In some embodiments, sensor component 112 can interact with vehicle controls or monitors to normalize sensed impulses related to mechanical sensors. For example, by monitoring the engine's rotations per minute as well as the electrical connection to brake lights, acceleration and deceleration can be determined where no accelerometer is available. Acceleration and deceleration can be used to explain some impulses to the mechanical sensors, and if a driver exhibits certain patterns (e.g., very aggressive acceleration or hard braking), these patterns can be removed from determinations related to road conditions to adjust for operator influence on sensed impulses. While these aspects have been described with respect to a mechanical sensor aspect to sensor component 112, it is appreciated that a variety of other techniques can be employed. For example, speed, acceleration and turning can be received from position component 124 as an alternative to various mechanical sensors.

A road condition detected by sensor component 112 or otherwise provided to system 100 can be associated with a condition code. A condition code can include, but is not limited to, characters (e.g., letters and numbers), symbols, patterns, and other machine-readable means of conveying information. In an embodiment, different identified road conditions can have different condition codes. In addition to providing condition codes for identified conditions, particular condition codes can be provided to indicate unfamiliar conditions, unknown conditions, or relate an uncertain condition to a similar or likely condition. In some embodiments, a condition code can include primary and secondary codes. In such embodiments, a primary code can indicate a hazard rating for current or forecasted road conditions. In examples of such an embodiment, an arbitrary hazard scale can be used (e.g., numbered 1-through-5, with 1 indicating low hazard and 5 indicating significant hazard). The secondary code can indicate a reason for the hazardous condition (e.g., arbitrary number or character set to mean rain, snow, others). In such embodiments, pairs, matrices or other combinations can be employed to convey the primary and secondary codes in a single transmission. For example, a code of “[3,6]” could indicate a hazard level of 3, and a reason code of 6. In this example, the hazard scale can be from 1-through-5, and the reason code “6” can mean sleet, thus indicating a moderately hazardous sleet condition. Those skilled in the art will appreciate other means of realizing and utilizing condition codes in view of the disclosures herein.

Sensor component 112 can interact with communication component 126. Communication component 126 can be a single device capable of multiple communication techniques, or multiple devices operating in conjunction in support of system 100. In some embodiments, communication component 126 receives information from sensor component 112 via BlueTooth®. In some embodiments, communication component 112 can send information to sensor component 112. In other embodiments, communication component 126 and sensor component 112 can exchange information using other means, including wired connections (e.g., serial cable, PS/2, network cable, universal serial bus, electrical cable), 802.11/Wi-Fi, infrared, and various near-field or other means of wireless data transfer.

Communication component 126 can transfer information received from sensor component 112 to server component 132. Server component 132 can accordingly process and store information received from sensor component 112, and build information local to the travel route of a vehicle to which the other components of system 100 are attached. Using information from system 100, server component 132 can map road conditions by associating road conditions from sensor component 112 with location data from position component 124, detailed infra. Server component 132 can associate times and external factors (e.g., air temperature, humidity, ultraviolet index, wind speed, time of day, time of year) with particular road conditions to facilitate understanding of how recently road conditions were mapped and update or predict current road conditions based on new data or estimates based on historical data and known external factors. Such aspects will be understood following thorough discussion of all features of system 100 and in view of the disclosures herein.

Server component 132 can be connected to a network or otherwise include or be coupled with equipment facilitating interaction with external entities. In an embodiment, server component 132 can access or receive additional information such as weather forecasts, traffic density information, and others, from a network (e.g., the Internet), news broadcasts, radio (e.g., weather band) and other sources to determine road condition information. In some embodiments, server component 132 can analyze information gleaned from external entities, at least in part to facilitate determination of road treatments and treatment priority, as discussed throughout this disclosure. The results of such analysis can be disseminated via server component 132 to one or more entities. In some embodiments, not all entities interacting with server component 132 have access to all analysis (e.g., subscribing commuter only sees resultant road condition information, municipal employee additionally sees treatment priorities). In some embodiments, information received from external entities or information from subsequent analysis can be used for the determination, generation, verification and updating of condition codes.

In addition, communication component 126 can receive information from server component 132. Server component 132 can store road conditions by location, time and other variables. Stored information from server component 132 can be transmitted to communication component 126 to facilitate the use of the stored information by other components within system 100.

Communication component 126 and server component 132 can interact according to a variety of techniques for remote communication. In an embodiment, server component 132 and communication component 126 interact via short message service (SMS) messages. In other embodiments, server component 132 and communication component 126 can interact using various cellular networks, including over voice or data spectrums, or others. In some embodiments, satellite communications can be employed to enable communication between communication component 126 and server component 132. In some embodiments, other radio technologies can be employed (e.g., high frequency, very high frequency, ultra high frequency band radios, that can use other technologies such as encryption, automatic link establishment, time syncing). In some embodiments, combinations or redundant multiple remote communication techniques can be employed.

In an embodiment, system 100 can store information from sensor component 112 and server component 132 locally. A local storage medium can be employed to store all data, past and present, related to road conditions, locations, and times, as well as other information. In an embodiment, system 100 includes only a local cache that is purged on-demand, at predetermined intervals, or as storage is needed. In some embodiments, system 100 “streams” information from sensor component 112 and server component 132, and the information ceases to persist after it is no longer being used at least in conjunction with interface component 128. Variations and combinations for storing road condition data and other information will be appreciated in view of the disclosures herein.

Position component 124 can monitor at least monitor the position of the vehicle. In some embodiments, position component 124 can include a global positioning system (GPS). The GPS can include technology that employs last known position, rate(s) of travel, direction(s) of travel, and route conditions to estimate a current position when GPS satellite signals are weak or lost. Other technologies, such as triangulation (or higher order propagation time/intersection-based location) can also be employed as alternative or supplemental means of maintaining an accurate location for a vehicle employing system 100. Positions provided from position component 124 can be provided to other components to adjust an interface, determine map locations, associate data with positions, push and pull information to and from remote services, and others.

Mapping component 122 can associate local data from sensor component 112 and server data received via communication component 126 with locations on a map or other graphical output. In an embodiment, sensor component 112 indicates a series of road conditions, which are mapped real-time to a map of the area. In an embodiment, the map of the area can be a globe, capable of adjusting to map to anywhere in the world. In other embodiments, the map of the area can be limited to a particular location, and local or regional maps can be loaded prior to utilization. In an embodiment, mapping component 122 has preexisting data of roadways. In some embodiments, not necessarily distinct from the former, mapping component 122 can develop maps of previously un-mapped roads based on information from position component 124 and information about other travelers along the route using information from server component 132.

In an embodiment, server component 132, another remote service, or a local storage medium can contain maps and/or map information for use in conjunction with mapping component 122. In an embodiment, maps can be purchased or exchanged, and may require subscriptions to install and/or continue use. In embodiments, maps can be updated. In some embodiments, a variety of map/map information standards can be employed, and alternative or competing maps can exist for the same area. In some embodiments, map information can include details on how maps are displayed and how road condition and other information is presented on the maps, or how predictive data (e.g. expected road conditions in a location with no recent data) is calculated.

Interface component 128 can receive information from other components to display a user interface including at least a map providing symbolic imagery reflecting road conditions. Interface component 128 can display map information received from at least mapping component 122, and the position, orientation, scale, field of view, and other map variables related to the map information can vary based on at least location information from position component 124. Interface component 128 can additionally receive further road condition information from server component 132 via communication component 126. The information from server 132 can provide road condition, location and time data for locations and times where system 100 was not present (e.g. recently passed or soon-to-be-reached areas, areas within a radius of system 100's current position, areas in system 100's direction of travel, and others) that can be used by mapping component 122.

Interface component 128 can display road condition and other information on a map according to a variety of visual representations. Most frequently, colors and symbols can be used to indicate information of interest to an operator, planning team, etc. For example, roads that have no known hazards can be shown in green, while roads known to have ice or ice hazards can be shown in blue. Roads with high temperature surfaces can be shown in red, and roads with unknown conditions can be shown in black. These colors are merely meant to present appreciable examples, and other variants and color schemes fall comfortably within the scope of the subject innovation. Road colors can be indicated by filling the entire roadway, filling part of the roadway, or lining one or more sides or a portion within the roadway on the map displayed on interface component 128. A user can additionally be shown how recently the road data was taken according to varying symbols, as well as symbol shape, size and/or color coding. In embodiments, colors or symbols overlaid on a map using interface component 128 can indicate particular conditions. For example, a road colored blue can be shown to be cold enough for risk of ice, and an icon (e.g., image of a plow, salt shaker, or others) to indicate that the road has been treated for snow or ice. If the last temperature measurement was a length of time ago (e.g., 1 hour, 2 hours, and others), the color indicating temperature can vary. In some embodiments, several brackets of time can be employed with several colors or opacities associated with the brackets. For example, a temperature measurement indicating an ice risk within the past hour can be indicated in dark blue, a temperature measurement indicating an ice risk between one and three hours old can appear in a mid-blue, and temperature measurements indicating an ice risk older than three hours can appear in a light blue. Alternatively, the opacity can decrease (or transparency increase) percentage-wise with time. In some embodiments, brackets can be used at discrete opacity intervals (e.g., opacity goes from 100%, to 67%, to 33%) or can vary continuously according to time (e.g., opacity at 100% at time measurement taken, 0% after 4 hours).

Where icons or symbols are used, similar color and/or opacity techniques can be employed to indicate the “freshness” of the displayed data. Alternatively, different symbols can be employed to indicate different data context. In an embodiment, a question mark or other uncertainty indicator can be appended to an icon denoting the possibility of changed conditions. For example, a recently plowed road can utilize symbols indicating the road has been plowed. After the passage of time (e.g., 2 hours), a question mark can be shown on the icon. Alternatively, the icon can shrink with time. For example, a large icon can indicate the reflected condition has occurred recently, while a small icon can indicate the condition was recorded some time ago. Different colors or opacities for icons can also be employed. In some embodiments, icons or symbols change during discrete brackets (e.g., 3 arbitrary sizes or opacity values depending on time) or can adjust continuously according to time or conditions (e.g., grow or shrink continuously in a linear or nonlinear fashion). In some embodiments, entirely different icons, symbols, shapes, et cetera can be employed to indicate changing or changed conditions. In a non-exhaustive example, a roadway can show a river icon to indicate flooding, but after several hours, if the flooding is not reconfirmed, a puddle icon can be shown to indicate a possibility of high water. Other icons can be used for road temperature, precipitation, obstructions, et cetera.

In some embodiments, legends or scales can be displayed in-map or elsewhere via interface component 128. In one embodiment, a color gradient can be shown, with a continuous range of temperatures associated by color. In some embodiments, such a temperature scale can be relative, with different colors associated with different temperatures dependent upon the context of system 100. In alternative embodiments, a particular shade of a color is always associated with the same temperature or range of temperatures. Legends can appear to define icons or symbols, as well as modifiers or variants (e.g., denoting the age of sensor data, denoting that data was predicted). Other scales and legends, such as those frequently associated with maps (e.g., distance) can also be shown.

In some embodiments, statistical, environmental, and/or inferential technologies can be employed to estimate conditions where actual conditions are unknown. For example, a weather report, alone or combined with historical weather reports and associated road conditions in similar weather, can be employed to estimate road conditions where no recent data is available. In such situations, different colors, symbols or transparency levels can be used to notify a user interacting with interface component 128 that the conditions are estimated. In some embodiments, different colors, symbols, and/or styles can be used to indicate a confidence in estimated or old data.

In some embodiments, interface component 128 can allow a user to toggle between different times to view the ongoing changes to draw conclusions about current conditions or plan travel around condition cycles. Some of these aspects can be automated, calculated or discerned with artificial intelligence as is discussed herein throughout. In some embodiments, a user can select a time for which to display conditions. In some embodiments, a user can display all conditions for a window of time or display conditions for multiple times simultaneously.

In some embodiments, road conditions can be predicted via weather or other known environmental conditions. In some such embodiments, at least one of server component 132 and/or communication component 126 can receive information relating to a weather report or other information related to road conditions. Where no recent data is available (or in order to validate or supplement recent data) regarding road conditions, statistics relating to previous road conditions, or conditions on similar roads, can be utilized. Variables utilized in these situations can include air temperature, wind speed, humidity, air density, precipitation, UV (ultra violet) index, illumination, time of day, time of year, traffic levels, visibility, location, elevation or altitude, surrounding terrain (e.g., above-surface terrain features, vegetation, proximity to water), road continuity conditions (e.g., cracking, potholes, changing grade, changing materials), grade (e.g., incline or decline), curvature, road surface material(s) (e.g., asphalt, concrete, and/or color of the road surface), subsurface conditions (e.g., dirt or stone, water table, erosion), and others. Through these and other variables, information can be inferred about roads sharing similar variable values in similar environmental conditions. Such information can be utilized to validate data provided from a sensor to server component 132, validate data provided to communication component 126 from server component 132, estimate conditions where no recent sensor information is available, or estimate conditions where no sensor information is available at all. In some embodiments, predictions can be conducted locally, using only data stored and accessible to interface component 128 and mapping component 122 without accessing server component 132. In some embodiments, predictions can be conducted exclusively with data from server component 132. Various combinations or alternates will be appreciated in view of the disclosures herein.

Based on actual, historical and/or predicted road conditions, routes can be planned. In an embodiment, interface component 128 and position component 124 can calculate one or more routes between two or more points based on available trafficable surfaces between the two or more points. In an embodiment, a particular route, or time for travelling the route, can be selected based on road conditions. In an embodiment, a route can be changed real-time to accommodate changed road conditions and minimize travel time or risk. Both initial selections and changes can be based on improvements to road conditions, such as maintenance. For example, if a road is being plowed and treated (e.g., salted), a route can be chosen to select recently plowed and/or salted areas. Where plows or salt trucks' routes are known, routes can be selected to follow (literally, or to use recently maintained roadways) plows or salt trucks as much as possible to minimize risk and maximize speed. In an embodiment, departure timing or planned stops can be timed to avoid undesirable road conditions (e.g., system 100 schedules routes automatically around weather, times with historically or predicted poor road conditions, times between road maintenance). In some embodiments, stops or other changes can be suggested based on new road condition information from sensors along the route of travel or other sources. Routes and route planning, as realized through interface component 128, can include a combination of maps, overlaid visual indicators, voice or audio indicators, and others, allowing an operator to rely exclusively on interface component 128 to navigate to one or more destinations.

System 100 can be used in conjunction with road maintenance in addition to tracking current road conditions. In some embodiments, maintenance personnel and/or regular drivers can see when and where roads were recently maintained. For example, during ice and/or snow, interface component 128 can display when and where roads were salted on a map. In an embodiment, the freshness of this data can be indicated according to the above. In some embodiments, a time can be shown on a visual representation of road maintenance, indicating exactly when the road was serviced. In some embodiments, system 100 aboard maintenance vehicles can automatically update maintenance information. For example, system 100 can, via communication component 126 or other components, discern whether a plow is deployed and clearing the road, discern whether salt is being disbursed, and so forth. This time-labeled information can be provided to server component 132 to facilitate coordination between maintenance crews and provide updated information to vehicle operators in the area. In some embodiments, interface component 128 can provide a query to a maintenance crew to update information where the vehicle is not equipped to determine a status automatically. For example, if system 100 cannot interact with the vehicle to determine if a plow is employed, a maintenance worker can manually enter information related to plowing the road. In some embodiments, the location and time are automatically populated, only requiring the operator to confirm the road was in fact plowed. In other embodiments, an operator can or must enter all information relating to time, place and operations performed.

In some embodiments, different user levels can be provided to prevent tampering. For example, maintenance workers can have increased permissions to provide server 132 with information. In the same example, vehicles with sensors can have the ability to only provide sensor data to server 132. Other users can be limited to read-only permissions on server 132, able to view data provided but not add. In some embodiments, a sensor can be “trusted,” meaning it is recognized as a sensor acceptable to provide information to server component 132. In some embodiments, trusted sensors can include diagnostic modules that confirm proper functioning of the sensor and assure no tampering occurs before providing information to server component 132.

In some embodiments, coordination and optimization of maintenance efforts can be improved based on data provided to server component 132 and other sources. Different crews, shifts and municipalities can be provided with detailed information about when and where maintenance was performed, as well as the ongoing road conditions, to avoid redundant maintenance or “missed” areas where no maintenance is performed. In addition, the efficiency and effectiveness of maintenance can be discerned. For example, data provided to vehicles travelling along a road before and after a maintenance service is performed. The difference in road conditions can determine the effectiveness of the maintenance through a span of time and conditions. Historical information coupled with recent updates about road conditions can indicate road sections with increased risk or different rates of degradation in given conditions, allowing maintenance crews to prioritize areas requiring first or most frequent attention. The effects of different types of maintenance can be understood in terms of resultant road conditions as well (e.g., plowing versus salting). Thus, in a very focused example, municipal road maintenance crews can coordinate routes during an ice storm, selecting roads that typically experience the coldest temperatures, most ice, or most accidents to salt first, and avoid roads with no history of ice until other roads are salted. In the same example, the appropriate amount of salt can be discerned based on previously measured effects for a given amount of salt spread on a road surface. Further analysis can be conducted using, for example, traffic density and/or estimated residual treatment, based at least in part on current and/or forecasted conditions to prioritize maintenance activities. In these ways, costs can be minimized and resources preserved.

In some embodiments, maintenance routes and treatments can be automatically determined in advance or real-time as maintenance crews work. For example, given a user input, weather report, an update to the server from vehicles of unsafe road conditions, or other stimulus, routes can be determined for one or more maintenance vehicles to best address the conditions in terms of one or more optimized results. Such optimized results can include speed, efficiency, cost, effectiveness, duration of effectiveness (e.g., maximize time until next maintenance required), and others. In some embodiments, server component 132 calculates routes and sends route information to a maintenance vehicle. In other embodiments, a local component, such as interface component 128 or mapping component 122, calculates a route and sends the route to server component 132. In some embodiment, interface component 128 or mapping component 122 can alter or update a planned route based on updates from server component 132. In some such embodiments, updates can be based on the activity from other maintenance crews, “fresher” information relating to road conditions, the desired optimization strategy (or a change thereto), changed weather or other environmental conditions, et cetera.

In an embodiment, routes can be automatically created, or a request for routes can be processed, according to predictive technologies. As discussed above, traffic densities, road condition history, rates of change in road conditions, weather conditions, the effects of road maintenance, and other variables can be considered when planning routes. In some embodiments, artificial intelligence or other inferential technologies can be employed to determine or coordinate routes. In some embodiments, such processing can occur continuously through an event or series of events causing degraded road conditions, allowing ongoing updates to maintenance routes depending on the most recent information.

In some embodiments, recommendations for driving or operation can be presented. For example, based at least in part on a reading from a speedometer or speed calculated using position component 124, a driver recommendation can be presented for a driver to decrease speed due to icy roads, a speed zone, or other conditions making a reduction in speed prudent. In some embodiments, mapping component 122 can have information relating to speed limits, statistically dangerous roads (e.g. more accidents than other roads), and other route data, or required or suggested operating habits for a given route. In such embodiments, this information can be utilized in generating recommendations.

In some embodiments, system 100 can be employed for autonomous or aggregated vehicle data collection and analysis. Such data can include road condition data as well as ancillary data that can be collected based on system 100, its associated sensors including sensor component 112, position component 124, and other components with which system 100 can interact (e.g., speedometer, odometer, tachometer, gas gauge, pressure gauge, internal thermometers, and others). Additionally employed modules including tire pressure monitoring systems (TPMS), vibration detectors, shock (e.g., crash) detectors, tire slip detectors, active suspension systems, and others can be integrated or synced with system 100 to facilitate vehicle data collection and analysis.

Examples of uses for autonomous or aggregated vehicle data, as well as associated road conditions, can include information relating to the wear, degradation and service life of tires, suspension, road surfaces, and other materials that experience reduced performance or damage due to normal use, especially use affected by road conditions. In an embodiment, the “road life” (e.g., length of time, distance travelled, or other value indicating when a new component will be rendered unserviceable by way of intended wear) of a set of tires or a suspension can be estimated or analyzed in view of location or road conditions during use. In another embodiment, tire pressure and wear can be analyzed based on road temperature and other conditions. In the previous embodiment, pressure, wear and rates of change can be analyzed based on particular milestones, including arbitrary (e.g., tire with 10,000 miles) and/or relative (e.g., 10 percent of road life) markers, facilitating higher resolution analysis allowing focus or filtering for similar components in similar conditions. Vehicle data collection and analysis can serve a variety of other purposes as well. In some embodiments, road conditions and other vehicle data can be retrieved from system 100 subsequent to a vehicle accident, and used to determine road conditions or vehicle information preceding and during the crash. In some embodiments, such information can be sent to, for example, server component 132. In some embodiments, such data can be stored locally at system 100.

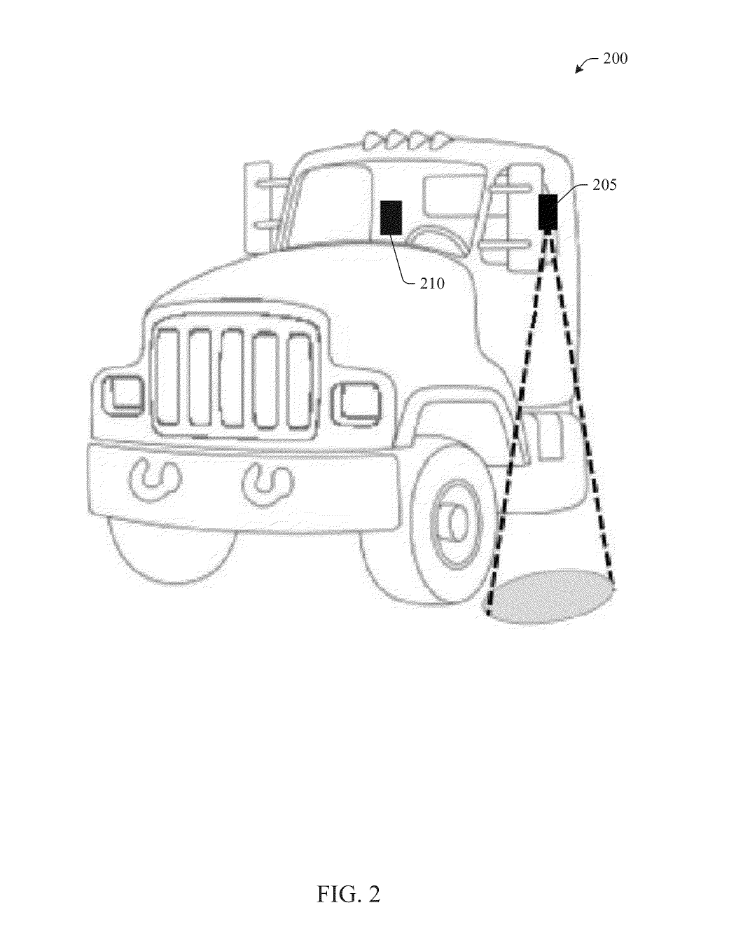

FIG. 2 illustrates an example road condition mapping system 200 on a vehicle in accordance with aspects disclosed herein. Mapping system 200 can include local sensor 205 and user device 210. Local sensor 205 and user device 210 can exchange information via wired or wireless means of transmitting and receiving data. In some embodiments, local sensor 205 and user device 210 exchange information via BlueTooth®.

In some embodiments, local sensor 205 can be any of a variety of infrared temperature sensors, such as active or passive infrared sensors useable for measuring a road surface temperature, including that described in U.S. Pat. Nos. 5,796,344, 6,166,657, and 6,206,299 (the entireties of these of which are incorporated herein by reference), or the RoadWatch® brand sensor system, and so forth. In alternative embodiments, other infrared temperature sensors can be used as local sensor 205. In some embodiments, local sensor 205 can be a different type of sensor, such as a mechanical sensor (e.g., gyroscope, accelerometer, and others), photo sensor (e.g., motion detector, light sensor, camera, and others), media detector (e.g., ice, rain, asphalt, concrete, etc.) or environmental sensor (e.g., barometer, liquid thermometer, humidistat, and others). In some embodiments, a plurality of sensors can be included in local sensor 205, or local sensor 205 can include multiple distinct components, sometimes in independent housings and with separate communication means, providing multiple sensor input types.

Local sensor 205 can provide sensor information to user device 210 to facilitate mapping of road conditions locally and elsewhere. In an embodiment, local sensor 205 provides real-time information (e.g., the conditions of the road currently being travelled) which is graphically portrayed on user device 210. In an embodiment, audible, vibratory and other notifications can be employed by user device 210 to provide information to a driver without requiring the driver's visual attention. Information from local sensor 205 can be associated with one or more maps and displayed or otherwise presented (e.g., audibly broadcast) via user device 210. In some embodiments, conditions detected using local sensor 205 can be employed by user device 210 to estimate conditions elsewhere.

User device 210 can be a third-party device operable with system 200 or a proprietary device. A proprietary device can include a device made expressly for use in conjunction with system 200. Third party devices can include cellular phones, smart phones, personal digital assistants (PDAs), tablets, computers (e.g., laptop or notebook computer, desktop computer, and others), navigation devices (e.g., Automatic Vehicle Locators [AVL], consumer GPS device), and others. In some embodiments, a display can be mounted or presented on a windshield or otherwise within the driver's field of view to minimize the time or distance of distraction from the road to utilize the device. In some embodiments, the display can be separate from other components of user device 210. For example, a computing and storage module can be located elsewhere, with only a display component mounted to the windshield. In such embodiments, wired or wireless connections can facilitate interaction between the display and components providing information to the display. In some embodiments, the display can be presented in a “heads-up” style, where a projection can overlay at least a portion of the driver's field of view. In some embodiments, a heads-up style display can be opaque such that the driver is able to see through the display, minimizing obstruction to the driver's field of view. In some embodiments, speakers can be used to notify the driver of road conditions or other information. In some embodiments, a hologram or translucent display can be projected onto the windshield or reflected elsewhere in the driver's compartment. In other embodiments, a separate display pane can be mounted (e.g., clear panel or see-through liquid crystal display screen) on the windshield, mirrors, or elsewhere.

In some embodiments, user device 210 includes communication means for communicating with external entities beyond local sensor 205. For example, in some embodiments, user device 210 can be a cellular telephone or smart phone capable of transmitting on cellular networks. In other embodiments, user device 210 can couple with a cellular telephone or other communication device to leverage the communication device's capabilities. In embodiments where user device 210 communicates with external entities, information about road conditions can be shared about locations remote from user device 210. In some embodiments, user device 210 can utilize SMS communication to exchange road condition information. In other embodiments, mobile data or voice networks can be utilized. In some embodiments, Wi-Fi can be used at least a portion of the time system 200 is working (e.g., when driving past or idling in a Wi-Fi hotspot location). In some embodiments, user device 210 can receive and cache (or store) information anticipated to be needed (e.g., along a planned route, along a likely alternative route, within a radius of travel, and others) when a communication connection is available, such that some information can be available when if the communication connection is lost.

In some embodiments, user device 210 can exchange information with other vehicles in user device 210's area (e.g., 50 miles, 100 miles, et cetera). In some embodiments, a user can select map options, or scale the map (e.g., show 100 square miles, show 200 square miles, et cetera) resulting in additional data being sought such that all visible map areas or selected options have road conditions and other information populated. This can be coordinated with or without a central server tracking the location of devices and sharing device information. In other embodiments, user device 210 can send and receive information about road conditions associated with a location, to a server, which provides information sent by others to user device 210. Thus, a map displayed on user device 210 can be populated with information about road conditions throughout the map area.

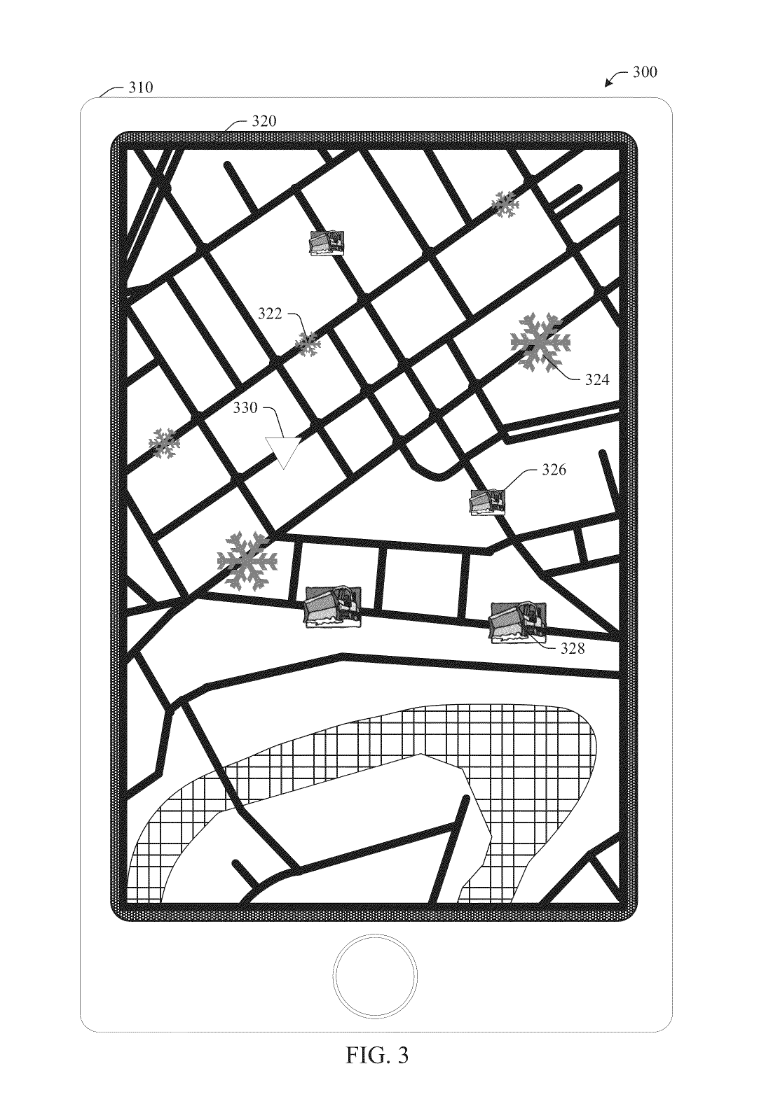

Referring now to FIG. 3, illustrated is an example user interface 300 in accordance with aspects of the innovation. User interface 300 can be accomplished via device 310. Device 310 can include, but is not limited to, computers (e.g., laptop or notebook, desktop, et cetera), tablets (e.g. Kindle®, Nook®, Galaxy Note®, iPad®) cellular/smart phones or PDAs (e.g., Android®, iPhone®, Blackberry®, Palm®), a GPS navigation device (e.g., Magellan®, Garmin®, TomTom®), and others. In some embodiments, device 310 is a standalone proprietary device. In such embodiments, narrower embodiments permit proprietary device 310 to interact with other devices to leverage their communication, processing or other resources.

Device 310 can include display 320. Display 320 can include, for example, a map. The map can display roads, terrain features (e.g., rivers, lakes, elevation contours, vegetation, and others), structures, and other aspects depicted on maps. In the limited example illustrated of display 320, the map shown includes roads and a river. In some embodiments, satellite views and alternative real-world pictures can be integrated into display 320 and maps displayed thereon.

Included in the map of display 320, or superimposed thereon, can be features related to road conditions and other information. In the limited example, several symbols are included. Plow symbols 326 and 328, and snowflake symbols 322 and 324, are shown different sizes. Device location 330 is also shown as a triangle. In an embodiment, snowflake symbols 322 and 324 can represent ice that has been locally detected (e.g., by a sensor on the vehicle in which device 310 is contained), detected by another vehicle, reported by a service (e.g. weather report), or predicted based on available information. In some embodiments, a larger icon can indicate a more recent report of ice, or a stronger confidence in the presence of ice (e.g., based on likelihood if predicted). Similarly, plow symbols 326 and 328 can represent potentially icy roads that have recently been maintained. The size of the symbol can indicate how recently a plow or salt truck serviced the area, or that one is present at this time. Device location 330 can be shown as, for example, a triangle, indicating current location and direction of travel. Display 320 only comprises a very limited example, and should not be interpreted as an exhaustive illustration of possible aspects, but rather a conceptual figure intended to suggest a few very specific aspects related to the scope and spirit of the innovation disclosed herein.

A variety of other aspects can be utilized with device 310 or incorporated into display 320. Display 320 can function alongside audible prompts and other notifications. Audible prompts and notifications can come from a speaker within device 310, vehicle speakers, and/or equipment including speakers within the vehicle (e.g., headset, cellular phone). In some embodiments, roads can include additional icons or colors. Additional icons and variants of icons can be employed. Transparency, alternative coloring, and other visual modifiers can be utilized to indicate additional conditions or information about such conditions (e.g., time since condition last observed, confidence in existence of condition, time until condition next mitigated). In some embodiments, legends, scales and additional information can be displayed on device 310. In such embodiments, further embodiments permit a user to toggle such additional information on and off, or customize the information. Additional information can include information from other aspects of device 310 (e.g., cellular telephone related information if device 310 is a smart phone) or similar information if other devices are integrated with device 310 (e.g., device 310 is a stand-alone device but communicates through a cell phone). In this way, display 320 can display text messages, emails, news, weather reports, and other information that is typically received through device 310 or other devices integrated with device 310 without disrupting the road condition function.

In some embodiments, users can customize what information is presented on display 320 and the way it is presented. Users can enable or disable the display of particular types of information. In some embodiments, users can change the icons presented to represent road conditions and other information, or change the way symbols or colors are modified depending on conditions. Other forms of customization can include defining alternative color schemes, setting the relative values of scales and legends, determining where remotely-described road conditions are displayed, and so forth.

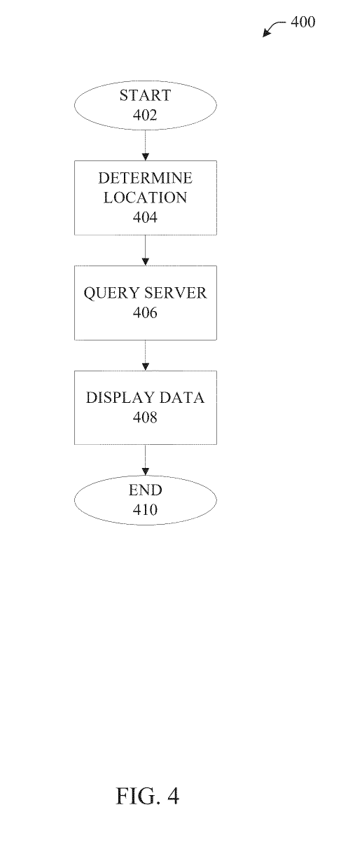

FIG. 4 illustrates a flowchart of an example method 400 for displaying road conditions without a local sensor. At 402, the methodology begins, and proceeds to 404 where a location is determined. Location can be determined by, for example, GPS, cellular triangulation, or other techniques. Once the device location is known, a server can be queried at 406 for road condition information associated with the location and surrounding areas. In some embodiments, the surrounding areas to be queried can be dependent upon a direction of travel, a rate of travel, a route, an alternative route, a radius around the device (e.g., 50 miles in all directions), a limited radius around the device (e.g., 50 miles in a 180-degree fan centered on the device's direction of travel), and others. The areas to be queried can be continuously updated as the device moves, updated at time and/or distance intervals, or updated as-needed, such as when a device reaches the end of an area for which road conditions are known, or reaches a buffer zone (e.g., 10 miles, 20 miles) that maintains standoff to prevent the device from “running out” of road condition information by passing the areas for which information is known.

At 408, the data is displayed. The data can be displayed on a device like those described herein, or other suitable devices. In some embodiments, the data is included in a dynamic map display, showing locations where road conditions are occurring. In some embodiments, the map can be arranged relative to the device and its direction and/or rate of travel. In other embodiments, the map can be absolute, showing conditions in a fixed area. In some embodiments, no map is shown, but information relating to immediate or upcoming road conditions is conveyed to a driver, visually, audibly, or otherwise. At 410, methodology 400 ends. It is to be appreciated that methodology 400 can repeat, remain at one step, or cycle between steps repeatedly through a trip.

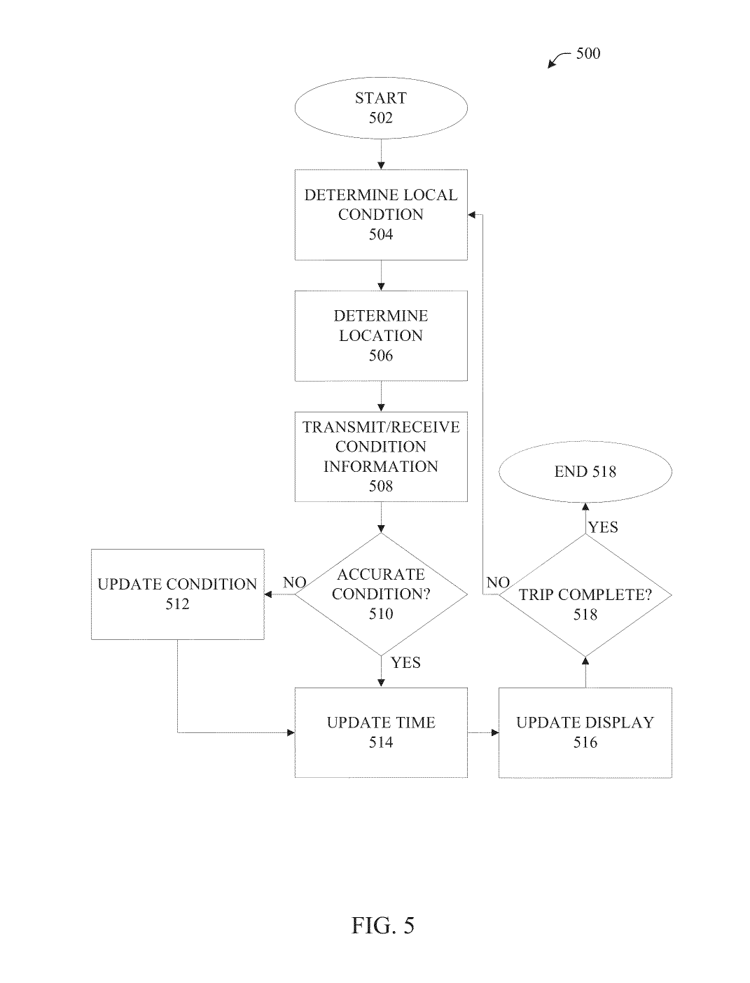

FIG. 5 illustrates a flowchart of an example method 500 for transmitting and receiving road condition data with a local sensor. Method 500 begins at 502 and proceeds to determine a local condition at 504. The local condition can be discovered by a local sensor as described herein. At 506, a location of a device or vehicle can be discovered, utilizing one or more techniques. In an embodiment, the device or vehicle can maintain its own distance internally without GPS, cellular or other signals. For example, the device or vehicle can store a previous location, and update the location based on rates and directions of travel. In one embodiment, a user provides a location input, from which future locations are calculated. In other embodiments, GPS, triangulation or other location methods dependent upon external signals can be employed.

At 508, condition information can be sent and received. The local condition, associated with the location and time of its detection by the local sensor(s), is sent to an aggregating entity that, at least in part, tracks road conditions in locations over time. Information about road conditions nearby or elsewhere can also be received for local use.

In some embodiments, permission to transmit and receive condition information at 508 is contingent upon an authentication or subscription. In some embodiments, transmitting current condition information can be, at least in part, quid pro quo required in exchange for a subscription to at least a portion of other condition information. For example, a service can require that a user provide local condition information to access other condition information. In another example, a service can offer remote condition information to a user, but the user's cost (e.g., one-time equipment bill, ongoing subscription fees, and others) is reduced for participating in the provisioning of local road condition information. In some embodiments, only authorized devices are allowed to access information retrieved remotely. An authorized device can be a specific device, a device that is authorized by an administrator (e.g., someone working with the subscription service), or a device that is authorized by the device user (e.g., authenticate on purchase via web interface, phone activation, or other technique). In some embodiments, devices can be interchangeable, but only permit one device per subscription at a time. In some embodiments, any device capable of launching an application or web interface can be employed. Some embodiments also permit institutional purchases of devices and subscriptions, where a plurality of devices and subscriptions are purchased, and some or all can be used simultaneously by an organizational purchaser.

At 510, an entity with which the device or vehicle communicates with at 508 can evaluate received information to determine if the condition reported at 508 is in accordance with other data received. If the condition is found to be accurate as previously known, the time associated with the condition can be updated at 514, thus confirming the condition more recently and showing a user that the information is “fresh” or current (e.g., road reported icy at 10:15 is reported to be icy again at 10:45). If the previously stored condition is not found to be accurate at 510, the condition can be updated at 512 (e.g., road previously had no ice and now has ice), and methodology 500 can proceed to associate a time with the new condition at 514.

At 516, a display on the device or in the vehicle can be updated. The display can reflect both the locally measured data (e.g. sensor data), as well as data received at 508. Thus, a user or driver can view at least immediate and nearby road conditions, or road conditions at a location of the user's choosing, on a graphical display.

At 518, a determination can be made as to whether the trip is complete. If the trip is complete, or if a user no longer desires road condition information, methodology 500 can end at 518. However, if the trip is not complete or the user still desires road condition information, the method can return to 504, permitting continuous updating of road conditions during its execution. The determination at 518 can be made continuously, periodically, or on demand from a vehicle component, a device component, or the user. In some embodiments, methodology 500 can go through several circuits including returning to 504 from 518 in a matter of minutes or even seconds. In other embodiments, conditions are only updated after a certain period of time or a certain distance travelled. In some embodiments, a user or device can select a preferred refresh rate for a determination of “no” at 518 to be executed or set pauses between cycles, in order to minimize communication costs, maximize battery life, or accomplish other sought ends.

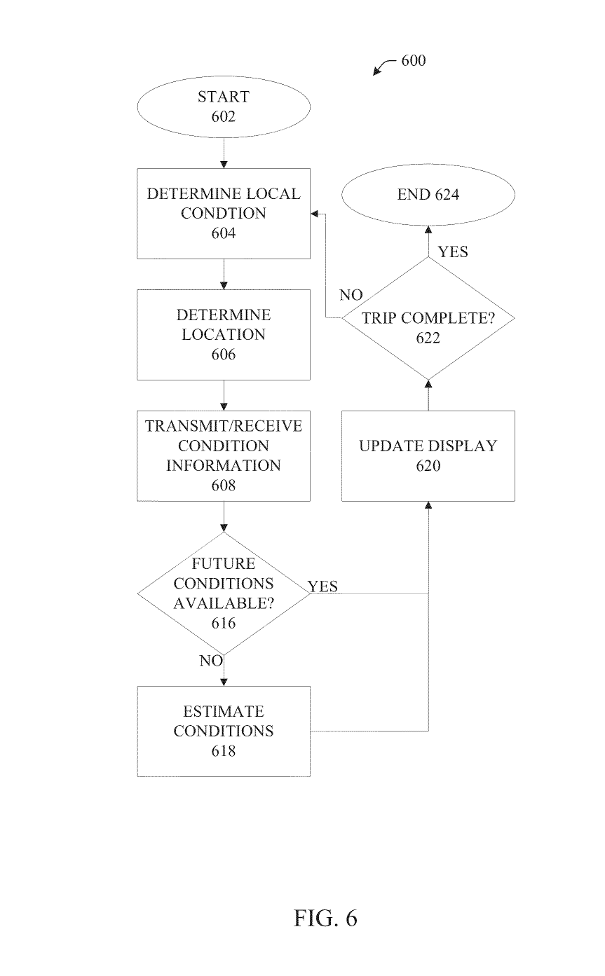

Illustrated in FIG. 6 is a flowchart of an example method 600 for estimating road conditions. Method 600 begins at 602 and discovers a local road condition using a sensor or other means at 604. At 606, a location is determined, to associate the discovered condition and to facilitate utilization of other road condition information related to the location. At 608, an attempt is made to transmit and receive information relating to road conditions. In at least one embodiment, step 608 is omitted. In at least an alternative embodiment, step 608 is attempted but fails due to, for example, lack of communication means or ineffective communication means.

At 616, a determination is made regarding whether future road condition information is available. Future road condition information can include, but is not limited to, information related to road conditions in the same vicinity of the location, road conditions ahead in a direction of travel, road conditions along one or more routes, road conditions along frequently travelled routes or roads, road conditions based on a request, road conditions based on the location with respect to a previous location, and others. In some embodiments, no communication means is available, or no external entity with which to communicate with exists. Regardless of the cause, if the determination at 616 is returned in the negative, method 600 proceeds to estimate future road conditions at 618. Estimation of future road conditions can be accomplished based on a variety of variables and techniques described herein.

After estimating future conditions at 618, or determining that future conditions were previously available at 616, method 600 proceeds to 620 where a user display is updated. The user display can be updated to display present and expected road conditions at the current location, on the route, within certain directions or proximities, or in arbitrary locations, relative to a vehicle or device, or absolute based on a chosen position. At 622, a determination is made as to whether the trip is complete. If the trip is complete, the method ends at 624. If the trip is not complete, or if further road condition data is sought, method 600 can recycle to 604 and continue to repeat loops updating information related to road conditions until the determination at 622 returns positive.

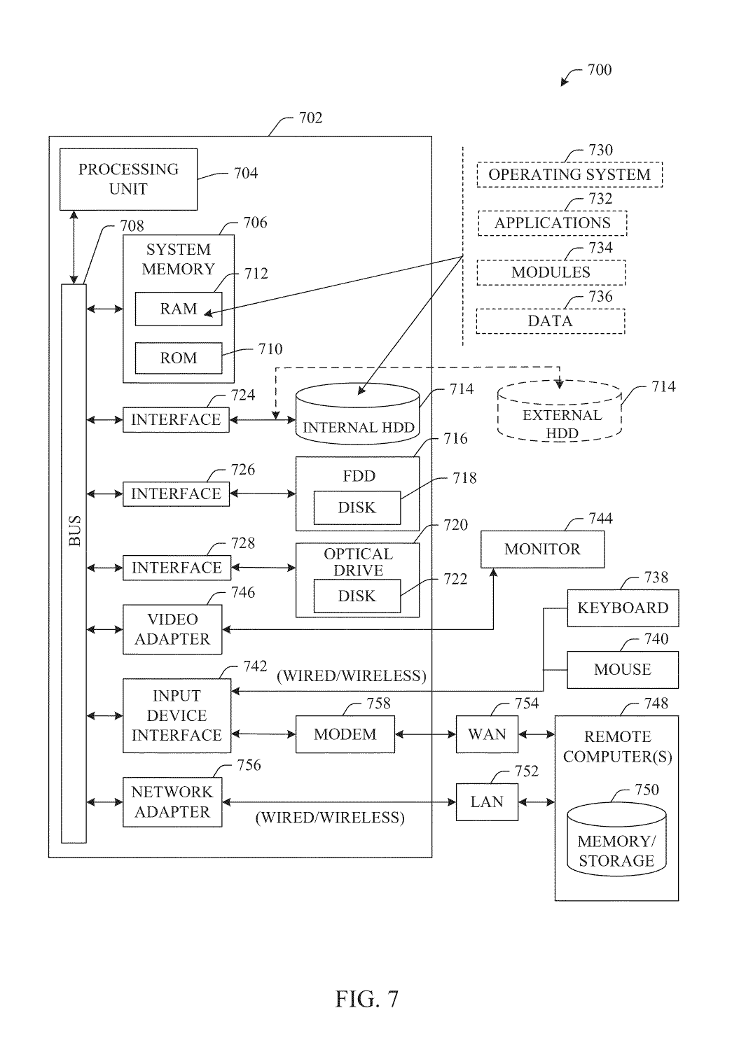

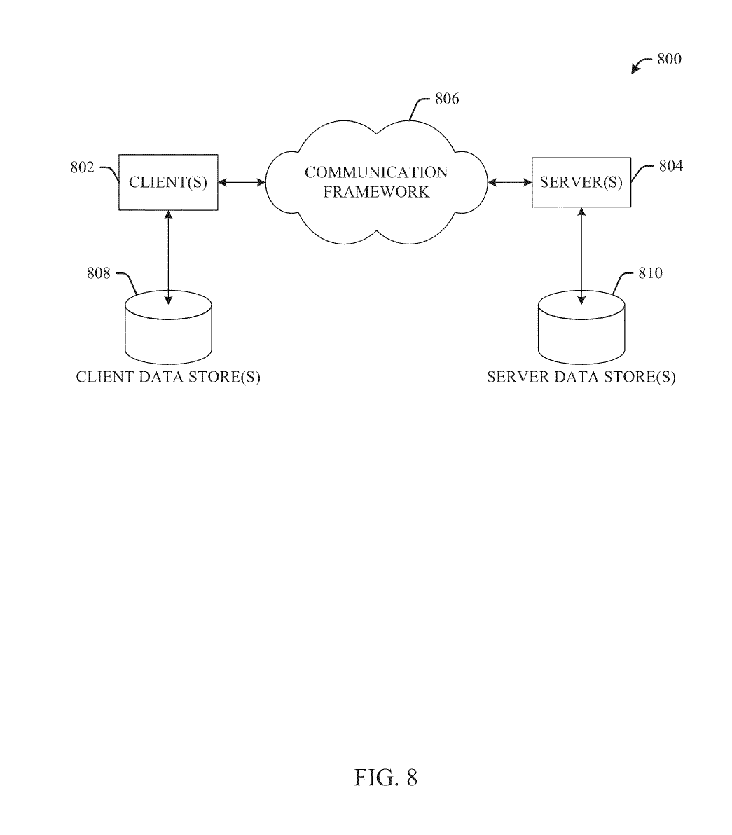

FIG. 7 illustrates a brief general description of a suitable computing environment wherein the various aspects of the subject innovation can be implemented, and FIG. 8 illustrates a schematic diagram of a client-server-computing environment wherein the various aspects of the subject innovation can be implemented.

Turning now to FIG. 7 illustrated is an example computing environment 700 that can be included in or used with some components in accordance with an aspect of the innovation. Computing environment 700 includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA). Alternatively or in addition, an external hard disk drive 715 may also be configured for external use in a suitable chassis (not shown), a magnetic disk drive, depicted as a floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drives 714, 715 magnetic disk drive 716 and optical disk drive 720 can be connected to the system bus 708 by a hard disk drive interface 724, a magnetic disk drive interface 726 and an optical drive interface 728, respectively. The interface 724 for external drive implementations can include Universal Serial Bus (USB), IEEE 1394 interface technologies, and/or other external drive connection technologies.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and system memory 706, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, et cetera

A monitor 744 or other type of display device is also connected to the system bus 708 via an interface, such as a video adapter 746. In addition to the monitor 744, a computer typically includes other peripheral output devices (not shown), such as speakers, printers, et cetera

The computer 702 may operate in a networked environment using logical connections via wired and/or wireless communications to one or more remote computers, depicted as remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742 as depicted. It should be appreciated that the modem 758 can be connected via a USB connection, a PCMCIA connection, or another connection protocol. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, et cetera) to provide secure, reliable, fast wireless connectivity. A Wi-Fi network can be used to connect computers to each other, to the Internet, and to wired networks (which use IEEE 802.3 or Ethernet).

FIG. 8 is a schematic block diagram of a sample-computing environment 800 that can be employed for practicing aspects of the aforementioned methodology. The system 800 includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). The servers 804 can house threads to perform transformations by employing the components described herein, for example. One possible communication between a client 802 and a server 804 may be in the form of a data packet adapted to be transmitted between two or more computer processes. The system 800 includes a communication framework 806 that can be employed to facilitate communications between the client(s) 802 and the server(s) 804. The client(s) 802 are operatively connected to one or more client data store(s) 808 that can be employed to store information local to the client(s) 802. Similarly, the server(s) 804 are operatively connected to one or more server data store(s) 810 that can be employed to store information local to the servers 804.

What has been described above includes examples of the various aspects and versions. It is, of course, not possible to describe every conceivable combination of components or methodologies for purposes of describing the various versions, but one of ordinary skill in the art may recognize that many further combinations and permutations are possible. Accordingly, the subject specification intended to embrace all such alterations, modifications, and variations that fall within the spirit and scope of the appended claims.

It is appreciated that, while aspects of the subject innovation described herein focus in wholly-automated systems, this should not be read to exclude partially-automated or manual aspects from the scope of the subject innovation. Practicing portions or all of some embodiments manually does not violate the spirit of the subject innovation.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers, and so forth). Such components, inter alia, can automate certain mechanisms or processes performed thereby to make portions of the systems and methods more adaptive as well as efficient and intelligent. By way of example and not limitation, the aggregation of password rules can infer or predict support or the degree of parallelism provided by a machine based on previous interactions with the same or like machines under similar conditions. As another example, touch scoring can adapt to hacker patterns to adjust scoring to thwart successful approaches.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A system for presenting road surface conditions, comprising:
a local sensor component that discovers a local road condition;
a location component that establishes a location of the local sensor;
a map component that associates the local road condition with the location of the local sensor; and
a presentation component that presents the local road condition at the location of the local sensor.

2. The system of claim 1, comprising a receiver component that receives information related to a remote road condition at a remote location.

3. The system of claim 2, where the information related to a remote road condition is presented by the presentation component at the remote location.

4. The system of claim 2, where the remote road condition is discovered by a remote sensor component at the remote location.

5. The system of claim 1, comprising an estimate component that estimates a remote road condition.

6. The system of claim 1, comprising a time component that associates a time with the local road condition and the location.

7. The system of claim 1, comprising a transmitter component that transmits information related to the local road condition at the location of the local sensor.

8. The system of claim 1, where the presentation component includes at least a visual display.

9. The system of claim 1, where the presentation component includes at least an audible notification.

10. A method for planning a route, comprising:
determining a first route condition on a first route;
determining a second route condition on a second route; and
selecting the first route or the second route based at least in part on the first route condition and the second route condition, wherein the selection is at least partially based upon road surface condition.

11. The method of claim 10, comprising detecting locally at least the first route condition or the second route condition.

12. The method of claim 11, comprising transmitting information related to at least the first route condition or the second route condition.

13. The method of claim 10, comprising receiving remotely information related to at least the first route condition or the second route condition.

14. The method of claim 10, where selecting the first route or the second route based at least in part on the first route condition and the second route condition avoids the first route condition or the second route condition.

15. The method of claim 10, where selecting the first route or the second route based at least in part on the first route condition and the second route condition seeks the first route condition or the second route condition.

16. The method of claim 15, comprising calculating a route treatment to mitigate at least the first route condition or the second route condition.

17. The method of claim 16, comprising completing the route treatment to mitigate at least the first route condition or the second route condition.

18. The method of claim 16, comprising coordinating a plurality of treatment entities to mitigate at least the first route condition or the second route condition.

19. The method of claim 10, comprising selecting a new route based at least in part on a change to the first route condition or the second route condition.

20. A method for displaying a plurality of road surface conditions, comprising:
determining a vehicle location;
discovering a local road condition at the vehicle location;
transmitting information relating to the local road condition and the vehicle location;
receiving information relating to at least one remote road condition at a remote location; and
presenting at least the local road condition at the vehicle location and the at least one remote road condition at the remote location.
